(19) United States
(12) Patent Application Publication
(10) Pub. No.: US 2016/0282539 A1
(43) Pub. Date: Sep. 29, 2016

(54) Cabinet Lamp

(71) Applicant: Zhongshan Winstar Electrical Co., Ltd., Zhongshan (CN)

(72) Inventors: Yu Li, Zhongshan (CN); Nan Chun Chen, Zhongshan (CN); Feng Du, Zhongshan (CN); Hui Liang Xin, Zhongshan (CN)

(73) Assignee: Zhongshan Winstar Electrical Co., Ltd., Zhongshan (CN)

(21) Appl. No.: 14/794,793

(22) Filed: Jul. 8, 2015

(30) Foreign Application Priority Data
Mar. 25, 2015 (CN) 201520184182.2

(51) Int. Cl. F21V 8/00; F21V 33/00

(52) U.S. Cl. CPC G02B 6/0038; F21V 33/0012; G02B 6/0073; G02B 6/0031; F21Y 2101/02

(57) ABSTRACT

A cabinet lamp is provided, including a connection substrate, a light guide plate and a top cover. There is a light emitting area on the connection substrate. On the top cover, there is a light emitting window corresponding to the light emitting area. The top cover presses the light guide plate onto the light emitting area. Light sources are disposed on the light emitting area and along the circumferential direction of the light guide plate. On the inner surface of the top cover, there is a protruded border along the circumferential direction of the light emitting window. A reflective surface is formed between the protruded border and the light emitting window. The reflective surface can reflect the light emitted from the light sources to the side face of the light guide plate. The side face of the light guide plate toward the light emitting area has a recessed structure.

### CROSS-REFERENCE TO RELATED APPLICATIONS

This present application claims the benefit of Chinese Patent Application No. 201520184182.2 filed on Mar. 25, 2015, the contents of which are hereby incorporated by reference.

### FIELD OF INVENTION

The present invention relates to a lamp, and in particular to a new cabinet lamp.

### BACKGROUND OF INVENTION

The existing cabinet lamps mainly include connection substrates which have light sources thereon. In general, the light sources are ordinary lamp beads or LED lamp beads, and the light sources are partially covered by a reflector cup having a horn structure. The bell mouth of the reflector cup is equipped with a corresponding light guide plate. The two translucent surfaces of the light guide plate are generally planar structure. Light emitted by the light source is totally reflected by the reflector cup onto the light guide plate, and then passes through the light guide plate. With the above structure of the cabinet lamps, when people turn on the cabinet lamps for use, the illuminated area of the cabinet lamps is small and the brightness thereof is high, and thus when people look at the cabinet lamps directly, people will feel dizzy and uncomfortable. In addition, existing cabinet lamps have a complex structure, and therefore the overall volume thereof is large and it will occupy a large space for installation, and meanwhile affect the appearance.

The present invention aims at solving the above defects.

### SUMMARY OF INVENTION

To solve the technical problems as mentioned above, the present invention provides a new cabinet lamp which, from bottom to top, includes a connection substrate, a light guide plate and a top cover. There is a light emitting area on the connection substrate. On the top cover, there is a light emitting window corresponding to the light emitting area. The top cover presses the light guide plate onto the light emitting area. Light sources are disposed on the light emitting area and along the circumferential direction of the light guide plate. On the inner surface of the top cover, there is a protruded border along the circumferential direction of the light emitting window. When the top cover is snapped onto the connection substrate, the protruded border hoods the light sources, and a reflective surface is formed between the protruded border and the light emitting window. The reflective surface can reflect the light emitted from the light sources to the side face of the light guide plate. The side face of the light guide plate toward the light emitting area has a recessed structure. When the light emitted by the light sources is reflected by the reflective surface to the side face of the light guide plate and then into the light guide plate, the incident light will be diffused by the recessed structure of the light guide plate and then emitted from the light emitting window. The present invention makes use of the aforesaid configuration, and so the light emitted by the light source is diffused by the recessed structure and then emitted from the light emitting window, resulting in softer lighting, a large exposure range and uniform brightness. Moreover, dizziness phenomenon caused by glare can be avoided.

In order to solve the existing technical problems, the present invention adopts the following technical solution.

The present invention provides a new cabinet lamp including a connection substrate and a top cover connected with the connection substrate. The connection substrate has a light emitting area. A light guide plate made of a transparent light-guiding material is provided on the light emitting area. Light sources are disposed on the light emitting area and along the circumferential direction of the light guide plate. The connection substrate has at least one terminal electrically connected to the light sources for connecting to power sources. The top cover is provided with a light emitting window corresponding to the position of the light emitting area. The light emitting window is used to fix the light guide plate at a location between the connection substrate and the top cover. On the inner surface of the top cover, there is a protruded border along the circumferential direction of the light emitting window for covering the light sources. A reflective surface is formed between the protruded border and the light emitting window for reflecting the light emitted by the light sources to the side face of the light guide plate. The side face of the light guide plate toward the light emitting area has a recessed structure for diffusing the light emitted on the light guide plate.

There is reflective medium on the light emitting area and between the light emitting area and the light guide plate.

The reflective medium is reflective coating or reflective stickers.

The recessed structure is concave holes or grooves uniformly distributed on the side face of the light guide plate. The side walls of the concave holes or grooves are curved surface or inclined surface.

The depth dimensions of the concave holes or grooves are different.

The depth of the concave holes or grooves gradually decreases from the centre of the light guide plate to the edge of the light guide plate.

The reflective surface is a curved surface or inclined surface. The light sources are LED lamp beads.

The connection substrate is a circuit board containing circuits therein. The inner side of the top cover is provided with recesses for mating with the terminals.

The number of terminals is two.

The top cover and the connection substrate are connected via screws. The connection substrate is provided with installation and connection holes for fixed connection with the cabinet or wall. The top cover is provided with installation and connection counterbores corresponding to the installation and connection holes. Each installation and connection counterbore is provided with a plug.

Compared with the prior art, the cabinet lamp of the present invention has the following advantages.

First, there is a recessed structure on the side face of the light guide plate. The reflective surface reflects the light emitted by the light sources to the side face of the light guide plate, and then into the light guide plate. The incident light is diffused by the recessed structure and then emitted from the light emitting window, resulting in softer lighting, a large exposure range and uniform brightness. Moreover, dizziness phenomenon caused by glare can be avoided.

The reflective medium is provided between the light emitting area and the light guide plate. After diffuse reflection, part of the light will irradiate on the light emitting area and will be totally reflected by the reflective medium to the light guide plate, and then diffused by the recessed structure, and emitted from the light emitting window. By using the reflective medium, it is guaranteed that the light generated by the light sources will not be weakened or lost after multiple reflections.

The recessed structure is evenly distributed on the side face of the light guide plate. The recessed structure can be concave holes or grooves. In order to make sure that the incident light in the light guide plate can be emitted from the light emitting window after reflection by the concave holes or grooves, the side walls of the concave holes or grooves are curved surface or inclined surface, but not vertical surface.

The depth dimensions of the concave holes or grooves are different. The depth of the concave holes or grooves gradually decreases from the centre of the light guide plate to the edge of the light guide plate, such that the light reflected by the reflective surface can irradiate on the side wall of each concave hole or groove. As a result, it is guaranteed that the brightness of the light emitted from every region of the light guide plate is uniform, and so the glare problem caused by high local luminance can be avoided.

The light sources are LED lamp beads which are disposed on the light emitting area and along the circumferential direction of the light guide plate, and thus it is avoided that the light guide plate directly superimposes on the light sources. Meanwhile, the connection substrate is a circuit board. Each electronic component is electrically connected to the circuit inside the circuit board via a plugin or patch manner, and this facilitates assembly. The inner side of the top cover is provided with recesses for mating with the terminals. By this structure design, the thickness of cabinet lamp of the present invention is minimized, resulting in a thinner size than existing products. In addition, the installation of the cabinet lamp occupies a small space.

When the cabinet lamp of the present invention is connected to the cabinet or wall through the installation and connection holes of the connection substrate and the installation and connection counterbores of the top cover, the installation and connection counterbores are sealed off by the plugs, making the surface of the top cover smooth and thus a better appearance and integrity.

### DESCRIPTION OF DRAWINGS

With the accompanying drawings, the embodiments of the present invention will be further described below.

FIG. 1 is a structural diagram of the present invention in the first embodiment.

FIG. 2 is a top view of the present invention in the first embodiment.

FIG. 3 is an exploded view of the present invention in the first embodiment.

FIG. 4 is a structural diagram of the connection substrate and the components thereon in the first embodiment of the present invention.

FIG. 5 is a first structural diagram of the light guide plate in the first embodiment of the present invention.

FIG. 6 is a second structural diagram of the light guide plate in the first embodiment of the present invention.

FIG. 7 is a structural diagram of the top cover in the first embodiment of the present invention.

FIG. 8 is a sectional view of FIG. 2 along A-A direction.

FIG. 9 is a structural diagram of the present invention in the second embodiment.

FIG. 10 is a top view of the present invention in the second embodiment.

FIG. 11 is an exploded view of the present invention in the second embodiment.

FIG. 12 is a structural diagram of the connection substrate and the components thereon in the second embodiment of the present invention.

FIG. 13 is a first structural diagram of the light guide plate in the second embodiment of the present invention.

FIG. 14 is a second structural diagram of the light guide plate in the second embodiment of the present invention.

FIG. 15 is a structural diagram of the top cover in the second embodiment of the present invention.

FIG. 16 is a sectional view of FIG. 10 along B-B direction.

### DETAILED DESCRIPTION OF EMBODIMENTS

In combination with the drawings, the embodiments of the present invention will be described below in detail.

The present invention is a new cabinet lamp including a connection substrate 1 and a top cover 2 connected with the connection substrate 1 via screws. The connection substrate 1 is provided with installation and connection holes 13 for fixed connection with the cabinet or wall via screws. The top cover 2 is provided with installation and connection counterbores 14 corresponding to the installation and connection holes 13. Each installation and connection counterbore 14 is provided with a plug 15. When the connection substrate 1 and the top cover 2 are fixed on the cabinet or wall via screws, the installation and connection counterbores 14 are sealed off by the plugs 15, making the surface of the top cover 2 smooth and thus a better appearance and integrity.

The connection substrate 1 has terminals 5 electrically connected to the light sources 4 for connecting to power sources. The connection substrate 1 is provided with a light emitting area 3. A light guide plate 8 made of a transparent light-guiding material is provided on the light emitting area 3. Light sources 4 are disposed on the light emitting area 3 and along the circumferential direction of the light guide plate 8. In this way, the design defect of directly superimposing the light guide plate 8 on the light sources 4 in conventional design is avoided.

The light sources 4 are LED lamp beads. The inner side of the top cover 2 is provided with recesses 12 for mating with the terminals 5. When the top cover 2 is installed on the connection substrate 1 to form a finished product, the terminals 5 are embedded in the recesses 12. The height of the light sources 4 is less than the thickness of the light guide plate 8. Therefore, by using the above-described structural design, the overall thickness of the present invention is minimized and is thinner than that of existing products. As a result, the installation thereof takes up less space.

The top cover 2 is provided with a light emitting window 6 corresponding to the position of the light emitting area 3. The light emitting window 6 is used to fix the light guide plate 8 at a location between the connection substrate 1 and the top cover 2. On the inner surface of the top cover 2, there is a protruded border 7 along the circumferential direction of the light emitting window 6 for covering the light sources 4. A reflective surface 9 is formed between the inner side of the protruded border 7 and the light emitting window 6 for reflecting the light emitted by the light sources 4 to the side face of the light guide plate 8. The reflective surface 9 is curved surface or inclined surface. The side face of the light guide plate 8 toward the light emitting area 3 has a recessed structure 10 for diffusing the light emitted on the light guide plate 8. The reflective surface 9 reflects the light emitted by the light sources 4 to the side face of the light guide plate 8, and then into the light guide plate 8. The incident light is diffused by the recessed structure 10 and then emitted from the light emitting window 6, resulting in softer lighting, a large exposure range and uniform brightness. Moreover, high local luminance and dizziness phenomenon caused by glare can be avoided.

There is reflective medium 11 on the light emitting area 3 and between the light emitting area 3 and the light guide plate 8. Based on design needs, the reflective medium 11 can be reflective coating which is directly coated on the light emitting area 3. The reflective medium 11 can also be reflective stickers which are stuck on the light emitting area 3. When the connection substrate 1 is a circuit board, if reflective coating is adopted as the reflective medium 11, white paint with highly reflective performance can be directly coated on the light emitting area 3 via printing process in designing the circuit board. Part of the light undergoing diffuse reflection will irradiate on the light emitting area 3 and will be totally reflected by the reflective medium 11 to the light guide plate 8, and then diffused by the recessed structure 10, and emitted from the light emitting window 6. It is guaranteed that the light generated by the light sources 4 will not be weakened or lost after multiple reflections.

The recessed structure 10 is concave holes or grooves evenly distributed on the side face of the light guide plate 8. Based on design needs, the concave holes can be of different shape and the grooves can be annular grooves. In addition, the side walls of the concave holes or grooves are curved surface or inclined surface, such that the incident light in the light guide plate 8 can be emitted from the light emitting window 6 after reflection by side walls of the concave holes or grooves.

The depth dimensions of the concave holes or grooves are different. The depth of the concave holes or grooves gradually decreases from the centre of the light guide plate 8 to the edge of the light guide plate 8. When the light emitted by the light sources 4 is reflected into the light guide plate 8 by the reflective surface 9, part of the light can reach the centre of the light guide plate 8 and irradiate on the side walls of the concave holes or groves in the centre of the light guide plate 8 since the depth of the concave holes or grooves gradually decreases from the centre of the light guide plate 8 to the edge of the light guide plate 8. Hence the light reflected into the light guide plate 8 by the reflective surface 9 can irradiate on the side wall of each concave hole or groove, and so it is guaranteed that the brightness of the light emitted from every region of the light guide plate 8 is uniform.

The present invention has two terminals 5 such that the connection can be expanded when installing the present invention.

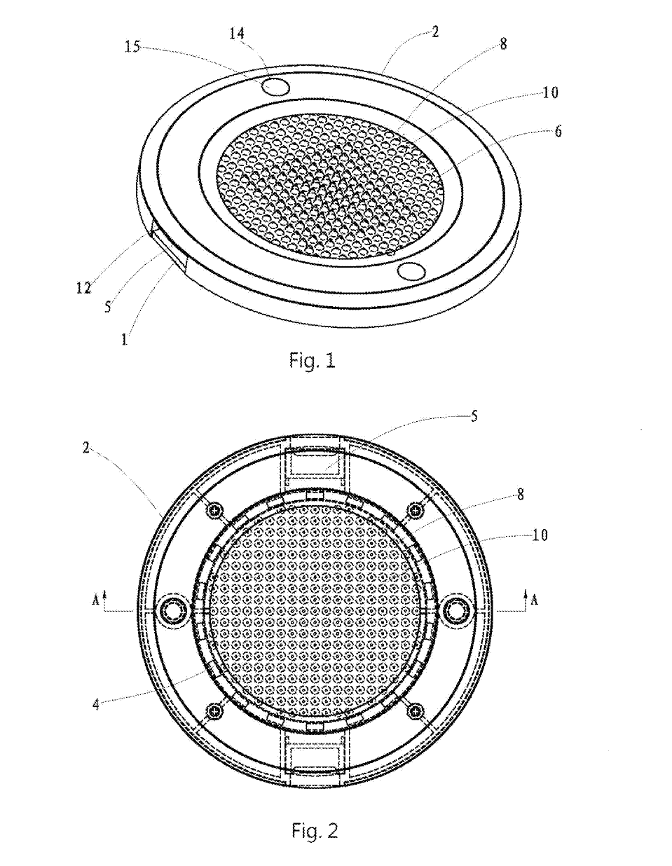

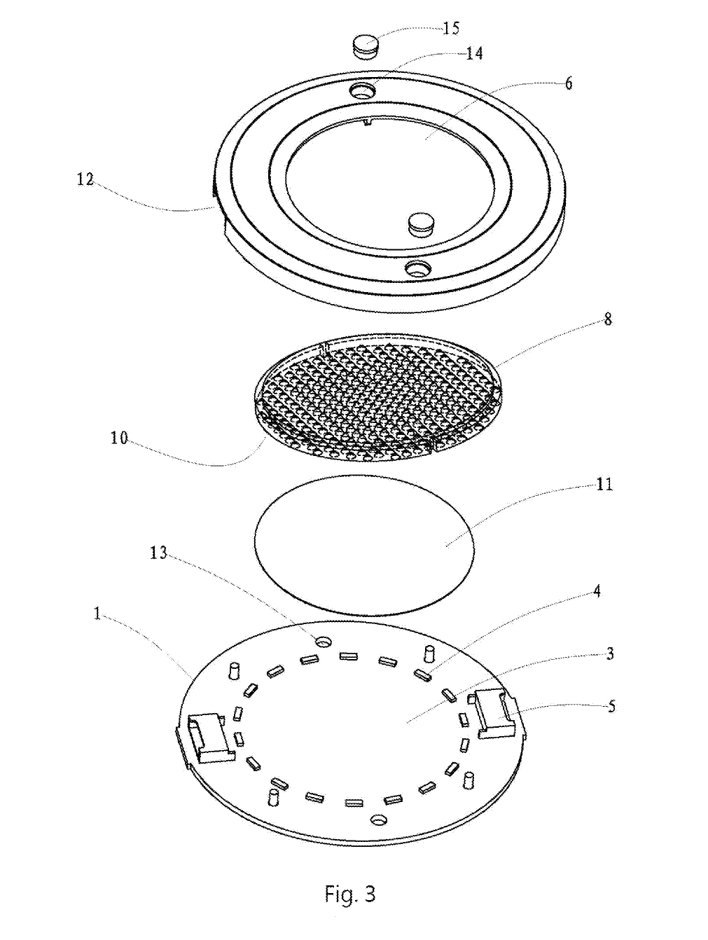

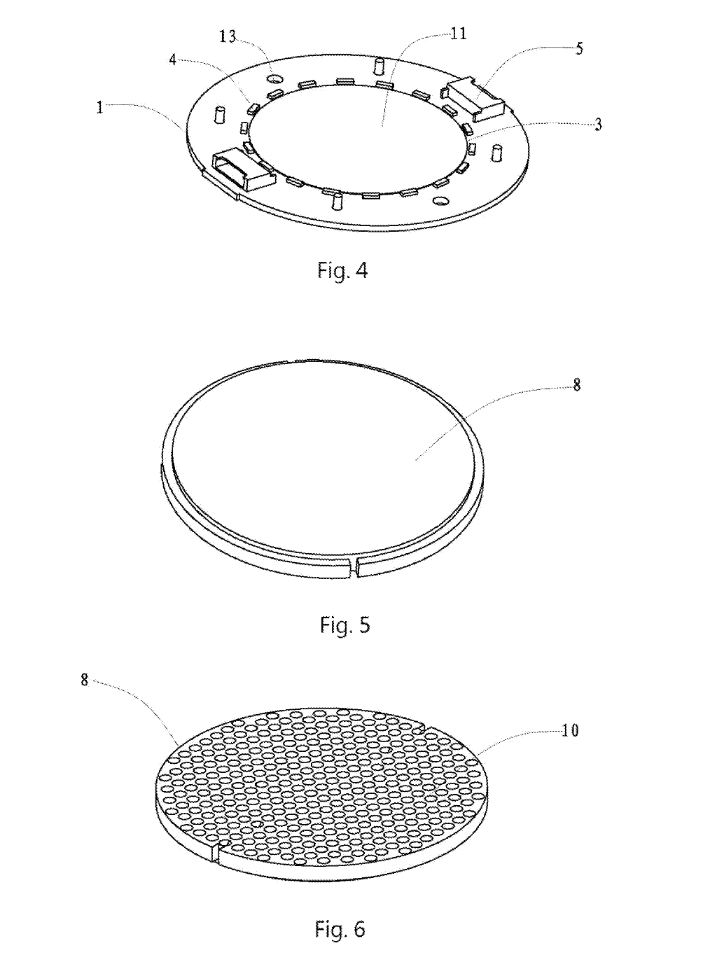

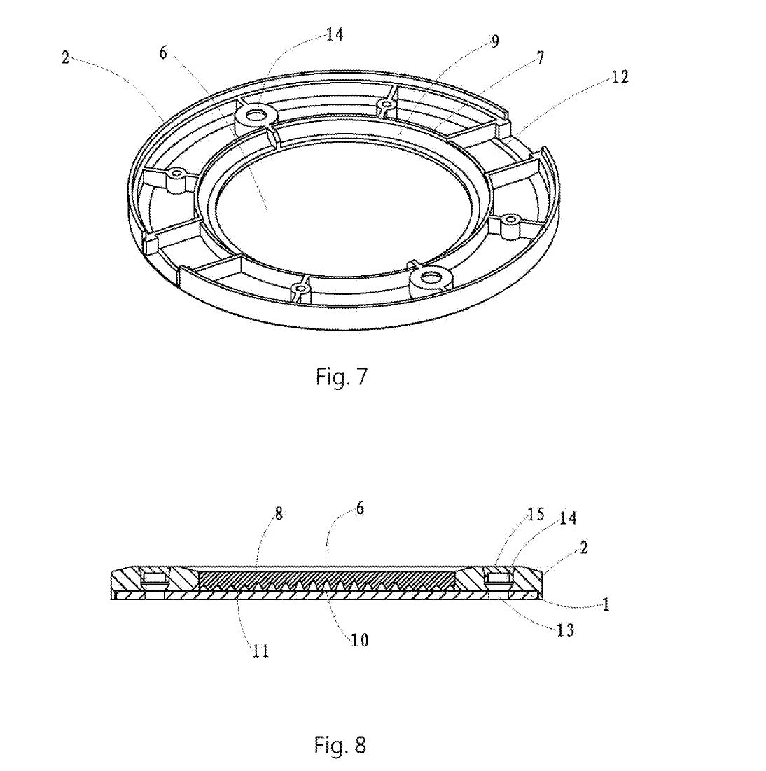

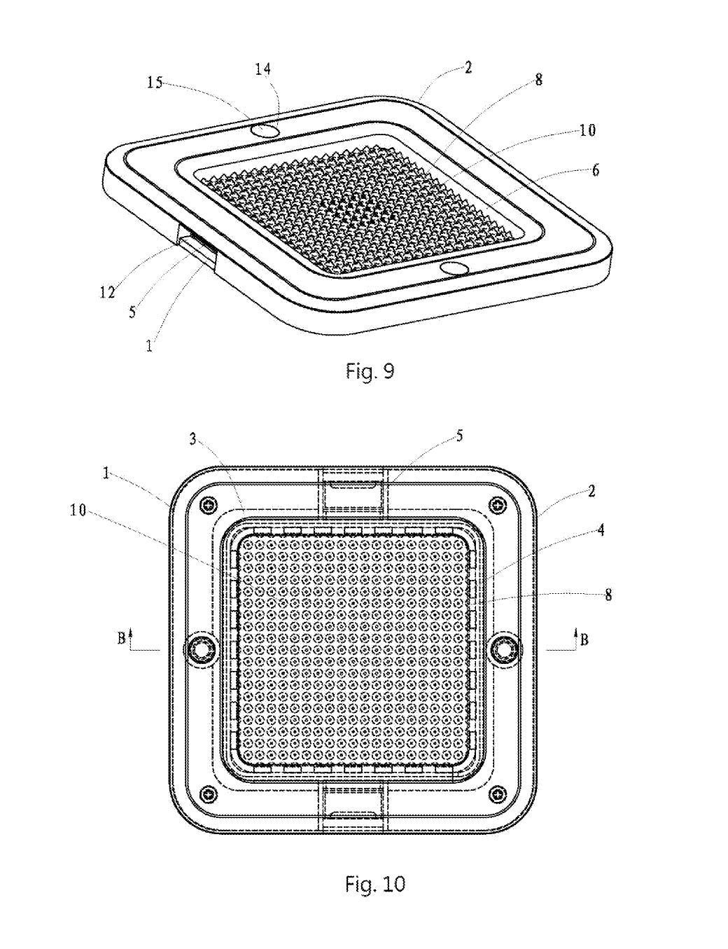

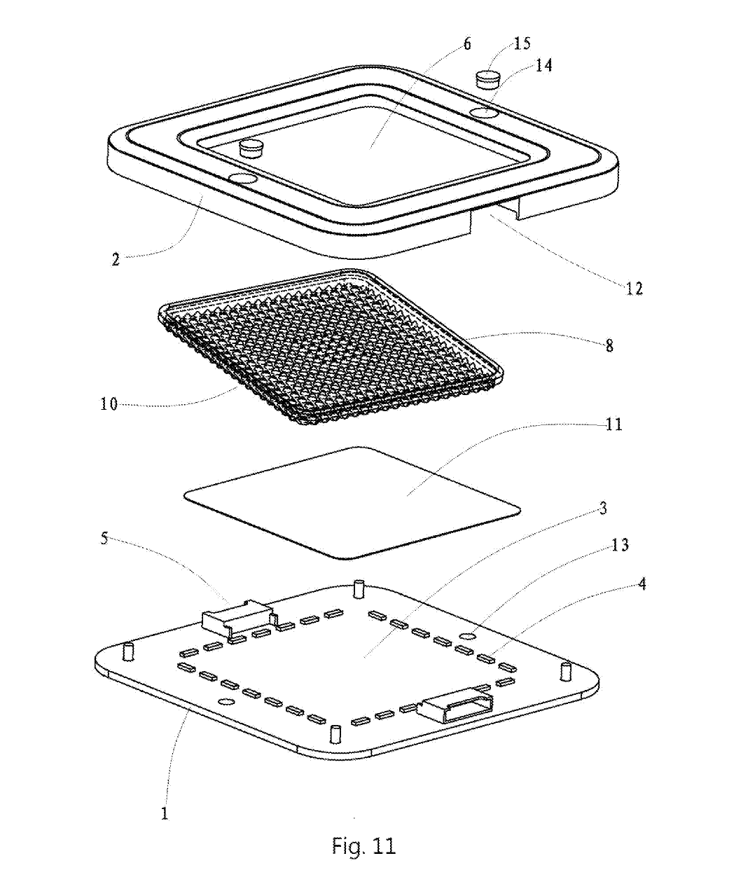

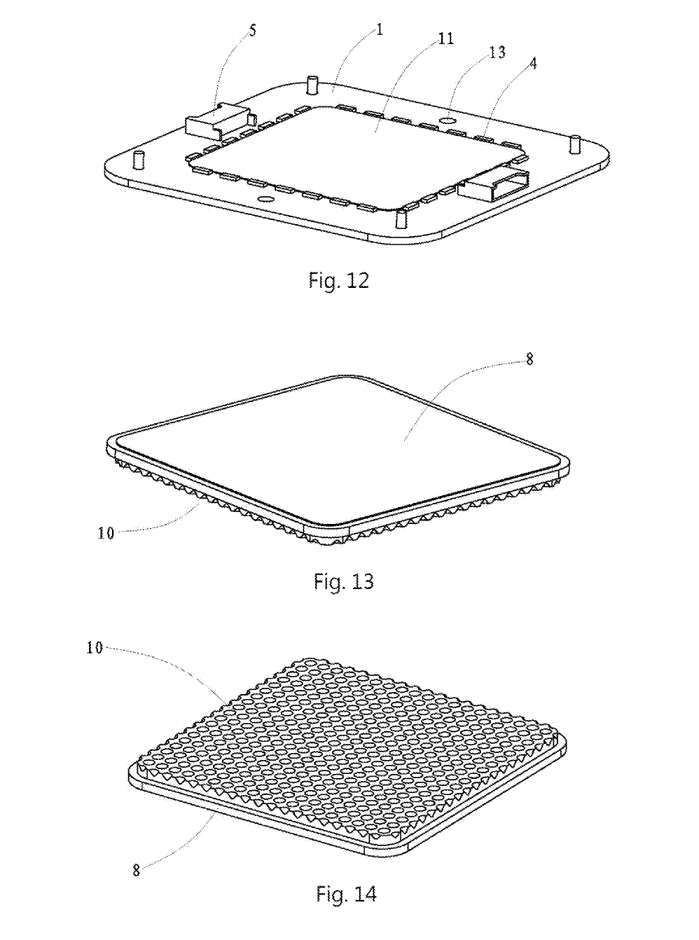

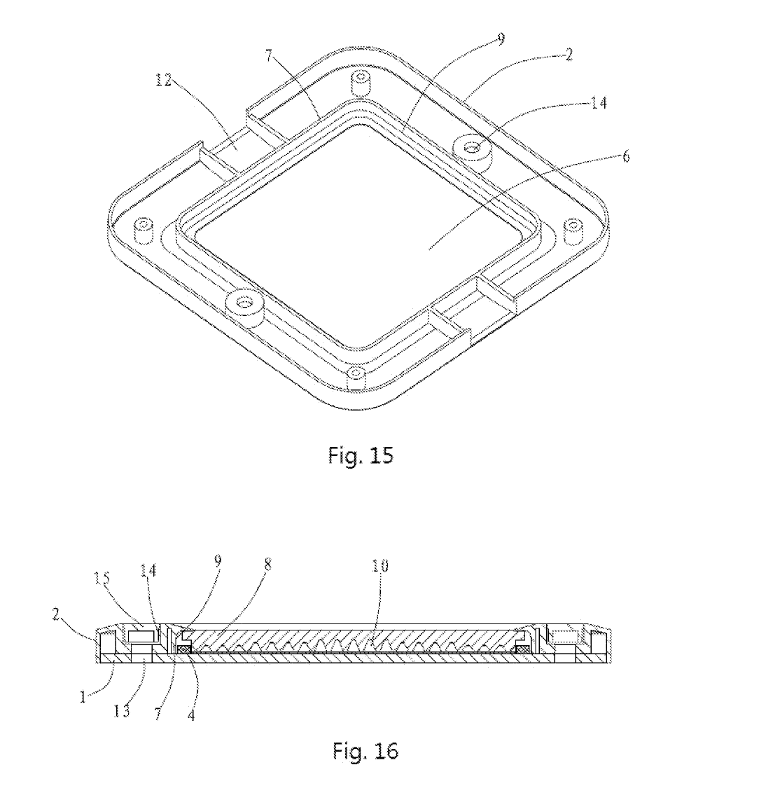

The above describes two embodiments of the present invention, FIGS. 1-8 corresponding to the first embodiment while FIGS. 9-16 corresponding to the second embodiment. In the two embodiments, the recessed structure 10 is concave holes which are tapered holes for facilitating processing.

The present invention is a circular structure in the first embodiment while it is a squire structure in the second embodiment. Furthermore, according to design needs, the shape of the present invention can be other polygon such as equilateral triangle, regular pentagon, regular hexagon and regular octagon.

What is claimed is:

1. A cabinet lamp comprising a connection substrate (1) and a top cover (2) connected with said connection substrate (1); said connection substrate (1) being provided with a light emitting area (3), a light guide plate (8) made of a transparent light-guiding material being provided on said light emitting area (3), light sources (4) being disposed on said light emitting area (3) and along a circumferential direction of said light guide plate (8), said connection substrate (1) having at least one terminal (5) electrically connected to said light source (4) for connection to power sources, said top cover (2) being provided with a light emitting window (6) corresponding to a position of said light emitting area (3), said light emitting window (6) being used to fix said light guide plate (8) at a location between said connection substrate (1) and said top cover (2), a protruded border (7) being provided on an inner surface of said top cover (2) along a circumferential direction of said light emitting window (6) for covering said light sources (4), a reflective surface (9) being formed between an inner side of said protruded border (7) and said light emitting window (6) for reflecting light emitted by said light sources (4) to a side face of said light guide plate (8), said side face of said light guide plate (8) toward said light emitting area (3) having a recessed structure (10) for diffusing light emitted on said light guide plate (8).

2. The cabinet lamp of claim 1, wherein a reflective medium (11) is provided on said light emitting area (3) and between said light emitting area (3) and said light guide plate (8).

3. The cabinet lamp of claim 2, wherein said reflective medium (11) is reflective coating or reflective stickers.

4. The cabinet lamp of claim 1, wherein said recessed structure (10) is concave holes or grooves uniformly distributed on said side face of said light guide plate (8), side walls of said concave holes or grooves being curved surface or inclined surface.

5. The cabinet lamp of claim 4, wherein depth dimensions of said concave holes or grooves are different.

6. The cabinet lamp of claim 4, wherein depth of said concave holes or grooves gradually decreases from centre of said light guide plate (8) to edge of said light guide plate (8).

7. The cabinet lamp of claim 1, wherein said reflective surface (9) is a curved surface or inclined surface, said light sources (4) being LED lamp beads.

8. The cabinet lamp of claim 1, wherein said connection substrate (1) is a circuit board containing circuits therein, an inner side of said top cover (2) being provided with recesses (12) for mating with said terminals (5).

9. The cabinet lamp of claim 1 comprising two of said terminals (5).

10. The cabinet lamp of claim 1, wherein said top cover (2) and said connection substrate (1) are connected via screws, said connection substrate (1) being provided with installation and connection holes (13) for fixed connection with a cabinet or wall, said top cover (2) being provided with installation and connection counterbores (14) corresponding to said installation and connection holes (13), each said installation and connection counterbore (14) being provided with a plug (15).

11. The cabinet lamp of claim 2, wherein said recessed structure (10) is concave holes or grooves uniformly distributed on said side face of said light guide plate (8), side walls of said concave holes or grooves being curved surface or inclined surface.

12. The cabinet lamp of claim 3, wherein said recessed structure (10) is concave holes or grooves uniformly distributed on said side face of said light guide plate (8), side walls of said concave holes or grooves being curved surface or inclined surface.

13. The cabinet lamp of claim 11, wherein depth dimensions of said concave holes or grooves are different.

14. The cabinet lamp of claim 12, wherein depth dimensions of said concave holes or grooves are different.

15. The cabinet lamp of claim 11, wherein depth of said concave holes or grooves gradually decreases from centre of said light guide plate (8) to edge of said light guide plate (8).

16. The cabinet lamp of claim 12, wherein depth of said concave holes or grooves gradually decreases from centre of said light guide plate (8) to edge of said light guide plate (8).

17. The cabinet lamp of claim 8 comprising two of said terminals (5).
